(19) United States
(12) Patent Application Publication
(10) Pub. No.: US 2010/0148065 A1
(43) Pub. Date: Jun. 17, 2010

(54) ELECTRON BEAM STERILIZATION MONITORING SYSTEM AND METHOD

(75) Inventor: JOHN P. KIVLEHAN, Mundelein, IL (US)

Correspondence Address: K&L Gates LLP, P.O. Box 1135, Chicago, IL, 60690-1135, US

(73) Assignees: BAXTER INTERNATIONAL INC., DEERFIELD, IL (US); BAXTER HEALTHCARE S.A., WALLISELLEN (CH)

(21) Appl. No.: 12/337,148

(22) Filed: Dec. 17, 2008

(51) Int. Cl. G01N 23/00

(52) U.S. Cl. 250/310

(57) ABSTRACT

A medical container sterilization apparatus includes: an electron beam generator; a probe placed in proximity to an electron plume projected from the generator; and electronics configured to accept a signal carried by the probe, the signal, the signal indicative of a sterilization level of the electron plume, the electronics further configured to indicate if the sterilization level is not sufficient. A medical container sterilization method includes: (i) collecting electrons from a sterilizing electron plume; (ii) generating a signal from the collected electrons; and (iii) determining from the signal whether the electron plume is sufficient to properly sterilize the medical container.

### BACKGROUND

Known electron beam accelerator tubes are in essence high voltage versions of traditional vacuum tubes. The tubes or generators typically include a heater, focusing plates and an anode made of a thin, reinforced film of titanium (referred to herein as the “electron beam window”). The above components are housed in a metal shell and evacuated to a very high vacuum. The anode's voltage potential can be eighty keV to 125 keV and positive with respect to the heater. Electrons that boil off of the heater filaments are therefore accelerated towards the highly positive window potential.

A completed current path exists between the tube and the high-voltage power supply once the heater achieves incandescence. The available electrons at voltage potentials below approximately eighty keV boil off the heater, impinge and imbed into the anode window and eventually recirculate through the metal tube shell and the high voltage power supply and are returned to the heater for re-emission.

When the voltage potential exceeds eighty keV, however, some of the electrons hit the titanium window with enough force and velocity to push their way through the thin titanium foil and into the outside environment. Any unreleased electrons continue to be recirculated internally within the closed loop tube circuit.

The electrons that escape the window travel at a substantial velocity, such that they can be can be used to dry ink or glue, or in the present case, sterilize medical items. The fast moving electrons sterilize the items or products in a number of ways. Within a predetermined distance from the window the force of the collision of the electron(s) on the medical product will annihilate surface bacteria.

Also, once the electrons leave the foil window, they collide with the air molecules to form a highly excited plasma “plume”. Within a direct strike distance many of these electrons hit the part to be sterilized. The colliding electrons form a chain reaction, like scattering billiard balls, adding electrons to some air molecules and stripping electrons of others, creating positive and negative unstable ozone ions. Ozone is highly toxic to living organisms. Further, the rapid deceleration of the electrons upon surface impact releases energy in the form of radiation, i.e., heat and x-rays, which also contribute to microorganism destruction.

The delicate foil window is supported by grating in the window opening. The grating prevents the foil from imploding under the high vacuum of the accelerator tube. This support consists of a copper plate with small holes placed at regular interval distances across the entire window area. The grating causes a portion of the total window area to be opaque to the transmission of electrons.

The electron tube will accelerate most of the electrons in a straight line from the heater to the window with little spread. Certain electron tubes have defocusing plates that diffuse the electrons before the electrons strike the titanium window to spread the electrons over a larger area of the window and at varying angles. The electron tube may also have multiple or side-by-side filament heaters to further add to the distribution of the electrons over the horizontally disposed window as much as possible.

The electron beam generator can fail or degrade for a number of reasons. For example, a titanium foil hot spot can occur due to contamination on its outer surface (oil, dust, etc.) via human touch during handling. Inadequate air knife cooling on the outside foil face and loss of water cooling in the tube jackets can also result in foil overheating, which can lead to foil puncture and tube implosion (rush of air into the inner vacuum space) and immediate loss of output electrons. The incandescing heater filaments vaporize on contact with the air.

The titanium foil can be formed improperly, e.g., a cold forming of the foil results in a thinner, weakened, non-homogeneous area, which in turn causes the foil puncture and tube implosion described above. The titanium foil seal to the housing of the generator can lose integrity, so that the porosity of peripheral seal gradually allows trace amounts of air into the generator's vacuum, shortening prospective tube life.

Excessive vibration of the tube and supporting heat structure, thermal cycling of the heater from cold or warm to hot, and higher that normal applied heater voltage can each result in premature filament failure. Moreover, the heater filaments suffer from surface contamination over time. Constituent alloys eventually oxidize under the very high temperatures of operation. The oxidants obscure the transmission of electrons from the heater filament's surface.

Electron beam generators that use two heater filaments can present a unique problem. Here, a power line monitor sensing the overall power draw of the tube circuit may not show a power drop even if one of the filaments malfunctions. For example, it has been found that one of the heater filaments can fracture, causing its loose end to move and touch the other working heater circuitry, so that the fractured heater still draws power. The input power usage remains at a normal level even though one of the electron beam filaments has been physically displaced, causing an area of the sterilization zone to be void of electrons and thus not sterilized properly.

When using the electron beam tube or generator for sterilization, it is important to know accurately and as soon as possible when the generator is not functioning properly. The present method of determining sufficient sterilization levels at the medical product, employs the use of dosimetry film. This film is either replaces the product at the strike distance or is affixed to the product surface before e-beam exposure. Film is placed on or near the product at statistically confirmed intervals during a production run to determine that sterilization levels have not changed during the interim. This monitoring process is very cumbersome. It entails proper film handling (i.e. orientation, placement, removal), and necessitates a quick time interval to the developing stage after exposure. The phenomenon of this film is that it will continue exposure even after the e-beam hits it by natural or artificial light. Product that is not properly sterilized may have to be discarded, re-sterilized or lead to a massive product recall if the batch is released to the public.

Further, it is desirable to know at what stage of degradation the electron generator is at, so that it can be replaced or repaired, e.g., during off-hours, preventing an assembly line from being shut down if the generator output falls below an acceptable output during production. The present disclosure seeks to address the above problems.

### SUMMARY

The present disclosure describes an electron output monitoring system for a medical container sterilization system using an electron beam generator or gun. The monitoring system extracts electrons from an electron plume that the generator or gun emits to deduce the status of the sterilization operation in real time. The electrons form an electrical current, which can be measured and which is indicative of the strength of the electron plume accelerated out of a titanium window of the electron beam gun or generator. The measured electrical current correlates to a to a specific sterilization dosage that the electrons impart to the irradiated part or product.

The sterilization dosage received by the indicated product can be confirmed using a dosimetry film for example. The system guarantees that the irradiated part receives an amount of sterilization dosage or energy that corresponds to a level that the dosimetry film confirms is sufficient to provide a proper level of sterilization to the irradiated part.

The monitoring system in one embodiment captures emitted electrons from the fringe or periphery of the electron beam plume, so as not to obstruct the center, sterilizing portion of the electron plume while sterilizing the product. The system in one embodiment uses a pair of probes. Each probe in one embodiment has one or two pickups or conductive branches that extend horizontally above and below the center of the electron plume. Each probe is placed about one of the two plumes that the generator or gun emits. The pickups or probe branches in one embodiment are made of gold to withstand the harsh environment around the electron plume. The branches of each probe are tied together electrically to sum their pickups from above and below the respective plume, for example.

The electron beam generator or gun in one embodiment uses two internal heater filaments that provide maximum electron distribution over the, e.g., three inch by ten inch, titanium foil window of the generator. The left heater filaments contributes to the window's left side. The right heater contributes to the window's right side. If either heater filaments fails, the electrons for that side of the window disappear, leading to improper sterilization. Two probes are provided for each generator accordingly. The overall system uses two generators (four total probes), so that the products can be fully sterilized on all sides without having to rotate the products.

The probes are mounted in an electrically insulated housing, which in turn can be mounted to the electron beam gun or generator face. The insulating housing in one embodiment also houses at least some of the electrical components that convert the electron beam current into a voltage for measurement. The insulating housing is machined ceramic in one embodiment, such that the probes and housing can each withstand the collective and destructive properties of ozone, x-rays and heat in the area of the electron plumes.

Each probe signal (collected from the upper and lower branches) is routed out of the hazardous electron beam chamber, via a conductor, housed in a coaxial cable. The cables are maintained at a same length and closely parallel to one another to provide a symmetrical balance of any noise that the conductors receive inductively along their paths.

The electrical current generated by the captured electrons forms a small direct current (“DC”) signal, which rides with a relatively much larger alternating current (“AC”) signal caused by the gas plasma electron beam plume. The signal is accordingly filtered heavily to remove the white noise component on each conductor. The system uses a series of active shield filters to remove the AC current component from the plume. The active grounding also cancels any inductively coupled antenna noise pickup. The signal is also isolated from the outside electrical world, so that any galvanic voltages due to ground loops do not occur. These procedures help to ensure that only the small DC signal is amplified.

The DC component of the input signal is extracted in one embodiment from the noisy AC component using a low pass filter (sometimes called a Butterworth Filter) in each of two differential input leads. The filter has a cutoff frequency, f_{c}, very close to zero hertz. The filter also slows down DC signal bobble.

The system also employs differential signal amplification, such that only the potential difference across the input resistor is amplified. Common mode noise on each of the input signal lines is cancelled using the equal length coaxial cables (mentioned above) for each of the differential input lines. Signal voltage is carried on the center conductors of each of the cables from the probe pickup to the remotely located amplification circuitry outside of the electron beam sterilization chamber. The ungrounded/floating shields of these cables are connected to operational amplifier circuitry that actively drives their potentials with a signal amplitude equal and opposite to extraneous noise signals (man-made or machine related) induced into the differential input lines.

The system also uses one or more balance instrumentation amplifiers that amplify the direct current signal to a measurable zero to five volt signal. A first amplification stage, for example, can be done with an instrumentation operational amplifier balanced precisely at the time of manufacture. The amplifier can have a gain capability of as high as 1000 to 1. An additional post operation amplifier stage follows the instrumentation amplifier bringing the final signal level to a useable industrial output voltage range, e.g., zero to five VDC. A voltage reversing clamp is used at the post amplifier output to prevent negative excursions in voltage at the output.

The system also uses power supply circuitry that achieves a quiet, balanced DC power for the instrumentation amplifier circuitry. A separate dual-tracking power supply maintains identical positive and negative rail voltages of, e.g., ±6 volts. When the positive six VDC power supply wanders slightly, the negative supply matches it. The power supply accordingly does not move the sensed DC signal artificially.

The signal in one embodiment is used to drive: (i) a voltage comparator that (a) establishes a preset threshold of sterilization, (b) provides a light emitting diode (“LED”) status indication, and (c) drives an optically isolated input to a controller, such as a programmable logic controller (“PLC”), which is for alarming and sterilization machine control; (ii) a display, such as multi-segment LED bargraph display that shows the signal level (e.g., bar mode used to show signal level and dot mode used to show threshold level); and (iii) an optionally isolated analog circuit, which can be used to drive a recorder, such as a multi-penned strip chart recorder and/or an analog PLC input for continuous, historical level recording.

In one embodiment under normal operation (adequate electron beam sterilization output): (i) a “beam status” indicator indicates normal operation (e.g., LED is lighted steady green); (ii) an optically isolated “OK” output to the PLC is made continuously; and (iii) the analog display shows how far above threshold the electron beam output resides (e.g., bargraph shows multiple lighted elements above established threshold). When the electron output drops below the established sterilization level: (i) the “beam status” indicator indicates inadequate operation (e.g., LED flashes red): (ii) the optically isolated output to the PLC is removed, indicating a system failure; and (iii) the analog display shows how far below the threshold the electron beam output resides (e.g., bargraph shows elements lighted only below the threshold).

In one embodiment, the system also includes a diagnostic apparatus, which allows the operator to test the integrity of the electron beam circuitry prior to operating the sterilization system. The apparatus includes a selector switch that allows the operator to choose between two test signals, which simulate an equivalent input to the electron beam circuitry.

The selector switch can select for example between half signal and full signal levels. The signals are sent to the probes and travel back through the circuitry as if actually generated at the probes. These artificially generated input signals provide a quick indication that the monitoring system if functioning properly across it normal range.

Each probe has its own LED bargraph indicator. The normal mode for this display is in the BAR mode. The BAR (several LED's light up) increases vertically as the e-beam signal gets stronger and vice versa. To check the set threshold level, a button is held depressed on the front panel. In this DOT display state, only one LED is lit up at a time. The position or number LED that is lit indicates the level at which the alarm threshold is set relative to the 0 to 5 volt range (e.g., if the 10th LED on a 20 element LED bargraph is lit, then the threshold level is set for 2.5 volts).

When the integrity of the electron beam monitoring electronics is verified, the operator can power the sterilization system, which for example involves energizing the electron beam emitting and high voltage system of the electron beam generator. The PLC mentioned above also monitors the status of the electron beam generator. When the PLC sees the continuous, “normal status” or “OK” input, the PLC's programming recognizes the input as an authorization to allow products or items to be moved into contact with the electron plume provided by electron gun.

As discussed herein, the products are sterilized from two electron generators placed on opposite sides of the product. Each generator in one embodiment has two heaters and thus two probe branches, totaling four probe branches per system. The PLC accordingly looks for two continuous inputs, one from each generator before allowing product to move into the sterilization zone. The system is accordingly able to discern and indicate which of the electron beam generators has failed, e.g., via the multi-channel chart recorder mentioned above. Either the PLC or the chart recorder sounds an alarm when the system fails.

It is accordingly an advantage of the present disclosure to provide an electron beam sterilization monitoring system that can ensure proper operation of the electron generator based on experimental data collected by comparing electron output level with adequate dosimetry film results.

It is another advantage of the present disclosure to provide an electron beam sterilization monitoring system that can operate in the harsh environment caused by the electron beam.

It is a further advantage of the present disclosure to provide an electron beam sterilization monitoring system that can detect if either heater filament of the electron beam generator fails.

It is yet another advantage of the present disclosure to provide an electron beam sterilization monitoring system that can detect premature degradation of the thermionic output emission of each heater filament of the electron beam over time.

It is still a further advantage of the present disclosure to provide an electron beam sterilization monitoring system that responds to contamination of the electron beam window, which occludes the window and reduces electron output emission.

It is yet a further advantage of the present disclosure to provide an electron beam sterilization monitoring system that provides real-time output evaluation.

It is still a further advantage of the present disclosure to provide an electron beam sterilization monitoring system that does not interfere with the sterilization process.

It is still another advantage of the present disclosure to provide an electron beam sterilization monitoring system that is capable of monitoring small signals.

It is still a further advantage of the present disclosure to provide an electron beam sterilization monitoring system that is capable of extracting a signal from a large noise created within a sterilization zone.

Further still, it is an advantage of the present disclosure to provide an electron beam sterilization monitoring system that is capable of isolating a small signal from machine noise (e.g., servos, relays, motors) and ground loop noise.

Moreover, it is an advantage of the present disclosure to provide an electron beam sterilization monitoring system that is repeatable from sterilizing machine to sterilizing machine.

Additional features and advantages are described herein, and will be apparent from, the following Detailed Description and the Figures.

### BRIEF DESCRIPTION OF THE FIGURES

FIG. 1 is a block diagram illustrating one embodiment of the electron beam monitoring system of the present disclosure.

FIG. 2 is a schematic diagram illustrating one embodiment of an electrical layout for the electron beam sterilization monitoring system of present disclosure.

FIG. 3 is a portion of the schematic of FIG. 2 illustrating the operation of the electron beam generator operating with the monitoring system of the present disclosure.

FIG. 4 is a portion of the schematic diagram of FIG. 2 further illustrating the operation of the electron beam generator operating with the monitoring system of the present disclosure.

FIG. 5 illustrates one embodiment for placement of the probes of the electron beam monitoring system of the present disclosure.

FIG. 6 is a portion of schematic diagram of FIG. 2 illustrating the signal collection portion of one embodiment of the electron beam monitoring system of the present disclosure.

FIG. 7 is a perspective view of one embodiment of the probe monitoring assembly of the present disclosure.

FIG. 8 is an elevation view illustrating one embodiment for the probe wiring and insulating enclosure of the present disclosure.

FIG. 9 is a cross-section view illustrating one possible cross-sectional shape for the electron collecting probe branches of the present disclosure.

### DETAILED DESCRIPTION

One embodiment of the electron tube or generator used with the monitoring system of the present disclosure creates an electron plume shown below. The plume has been found to extend for approximately three to 3.5 inches outside of the titanium window of the electron tube or generator. The amount of free electrons drops significantly after this distance. In one sterilization system, the item or product to be sterilized is conveyed between two tubes or generators pointed towards each other and having a window-to-window separation of approximately six inches. Such configuration sterilizes the product without having to rotate the product in the sterilization field. The figures below show a single electron beam tube or generator for convenience. The overall system in one embodiment however includes a duplication of the components shown below. That is, each electron beam tube is monitored by a pair of probes (each probe as shown below can have first and second or upper and lower branch wires). Each probe will have its own dedicated amplifier, comparator and alarm threshold circuitry, outputs driven via isolation to an output device such as a programmable logic controller (“PLC”), analog signal circuitry, e.g., to a strip chart recorder, display, such a light emitting diode (“LED”) display, and possibly associated power supply. Components common to both probes include, for example, a tracking power supply (e.g., ±six volts) and a precision voltage reference (e.g. five volts), each discussed in detail below. Multiple electron beam tubes may be provided and used for a particular application, requiring the above component distribution to be duplicated for each tube.

The electron output monitoring system (“EOMS”) of the present disclosure provides for the monitoring of the free electron output of an electron beam accelerator tube or generator output as it actively sterilizes a part or product. The EOMS system samples or collects electrons in zones peripheral to the central sterilization plume to minimize any shadowing or degrading of the sterilizing effect of the plume. The electrons in the periphery impinge the surface of the probes, which provide a current path to effect an electrical current signal. The probes can be of solid wire, hollow wire, wire mesh, grating, a solid shape (see e.g., FIG. 11) to provide a desired effect for a specific application.

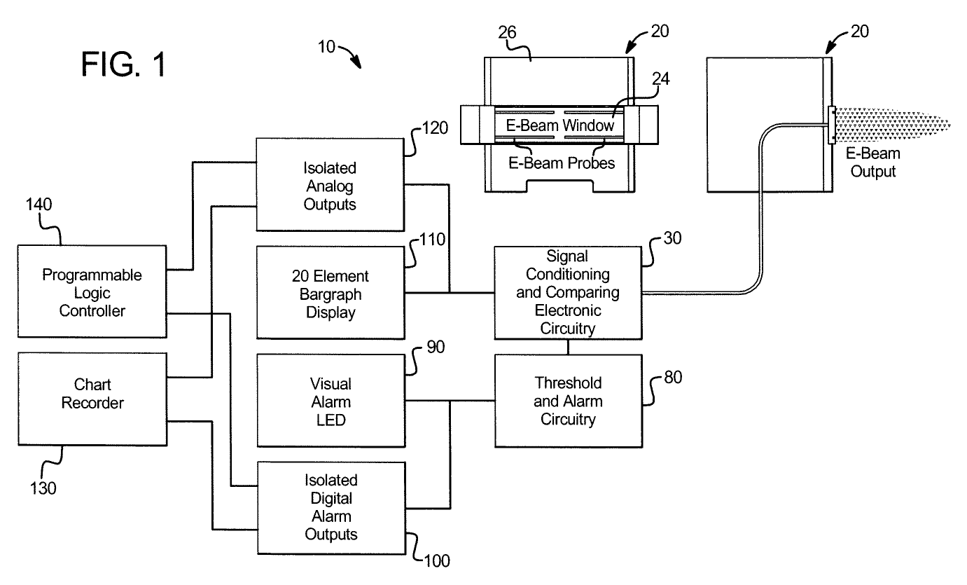

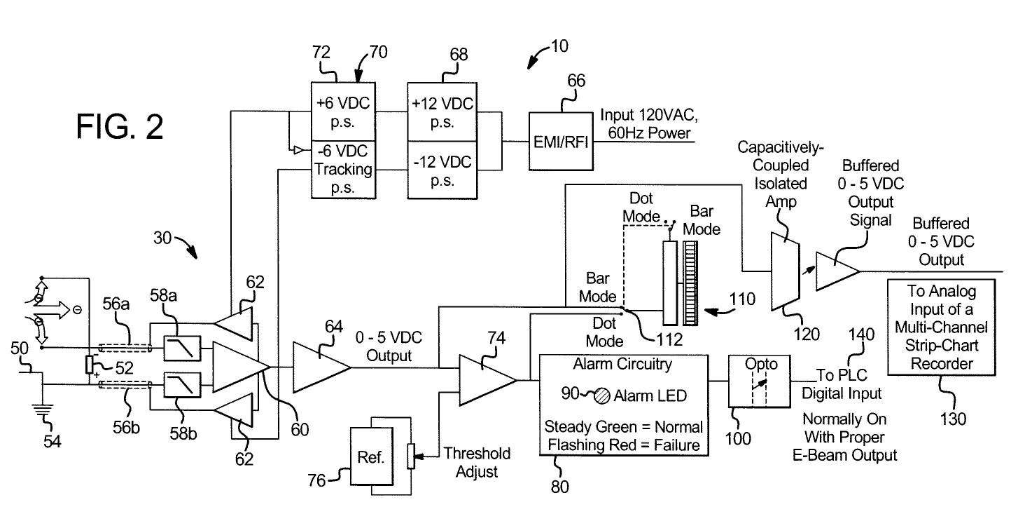

Referring now to the drawings and in particular to FIGS. 1 and 2, one embodiment of an EOMS system 10 is illustrated. System 10 includes an electron beam generator or tube 20. Tube 20 is shown in front and side views in FIG. 1. The current signal from the collected electrons is converted to a voltage signal and sent to signal conditioning and comparing circuitry 30. Signal conditioning and comparing circuitry 30 outputs to three primary components, namely, threshold and alarm circuitry 80, analog, e.g., bargraph, display 110 and isolated analog outputs 100. Alarm circuitry 80 in turn outputs to a visual alarm, e.g., light emitting diode (“LED”) 70 and isolated digital alarm outputs 100. FIG. 2 shows isolated analog outputs 100 driving a historical recorder, e.g., a multi-channel strip chart recorder 110, and isolated digital alarm outputs 100 driving a controller, such as a programmable logic controller (“PLC”) 140. FIG. 1 shows an alternative embodiment in which multi-channel strip chart recorder 110 and PLC 140 each receive isolated analog outputs 120 and isolated digital alarm outputs 100.

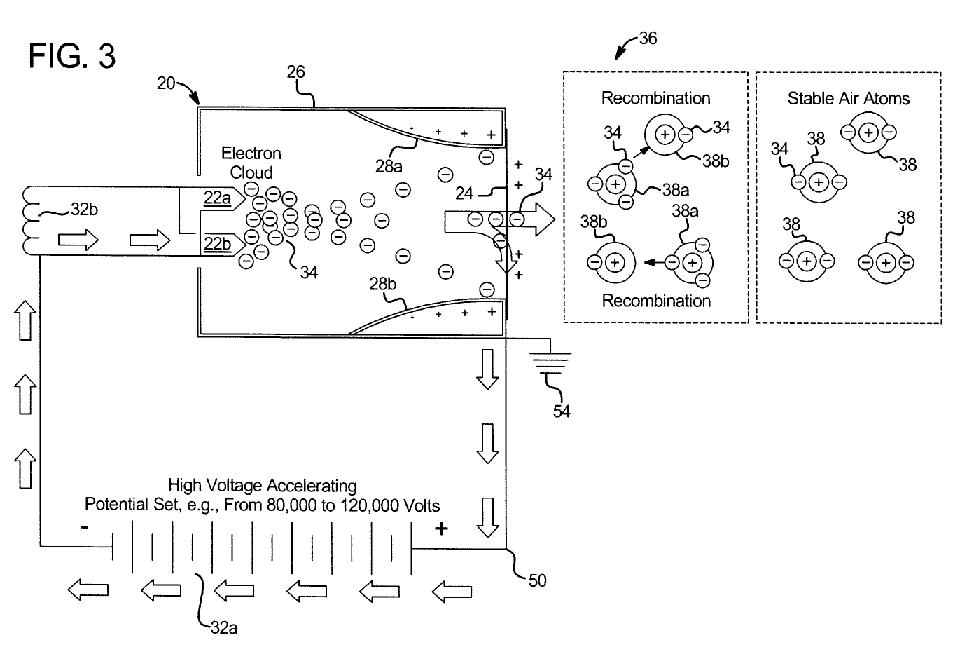

Referring now to FIG. 3, the operation of electron beam generator or tube 20 is illustrated in detail. Electron beam generator or tube 20 in one embodiment employs two heater filaments 22a and 22b to provide a better distribution of electrons across an entire, e.g., three inch by ten inch, exit window 24. Window 24 in one embodiment is copper mesh reinforced titanium. Window 24 is fixed to a housing 26 of generator 20. One electron beam manufacturer provides internal, electrostatically controlled focusing electrodes 28a and 28b to aid in the even distribution of the electron density across window 24.

Generator 20 applies a voltage from source 32a to a transformer 32b to power heaters 22a and 22b, boiling electrons off the surfaces of the heaters to form a cloud of negatively charged particles 34. Because of the very high voltages applied to transformer 32b, the tube maintains a very high vacuum to rid generator housing 26 of contaminating gases.

When housing 26 of the electron beam tube 20 is mounted to the medical conveying machine (not illustrated), titanium window 24 becomes grounded. For window 24 to have an electrical potential relative to heaters 22a and 22b (and the negative electrons), high voltage power supply 32a is wired such that the heaters 22a and 22b are at a negative voltage, e.g., negative 120,000 volts, with respect to window 24.

Electrons 34 are pulled from the electron cloud produced at heaters 22a and 22b and are accelerated towards titanium foil 24. On impact, some of electrons 34 return back to heaters 22a and 22b via high voltage power supply 32a and return loop 50. This internal circulating current along loop 50 as shown by the arrows is known as the “input current” of electron generator 20. All tube current is recirculated as “input current” at acceleration potentials below eighty keV using one type of electron beam generator. Housing 26 includes a water cooled jacket to remove enough of the extreme amount of heat that is produced by the electrons 34 colliding with window 24 to protect the window.

For the implemented generator 20, accelerating potentials greater than eighty kilovolts causes the electron energy to be great enough to tunnel through foil window 24 into a sterilization chamber 36. The free radical electrons 34 travel through the air colliding with oxygen molecules. The chain reaction collisions create an ionized ozone gas (O₃). Ozone is unstable and robs electrons from atoms it contacts. Ozone is also highly toxic and erosive and is thus a good sterilizer.

Electrons 34 slow down appreciably within approximately three to 3.5 inches outside of the window 24 (the sterilization zone in which the medical item to be sterilized is conveyed) due to the successive collisions in the air molecules. The moving electrons bombard and sterilize a surface of an object placed within this zone. Negative and positive ions 38a and 38b are created within the zone. At the end of the zone, the energy of the ions is diminished, so that the electrons 34 from the unstable ozone ions 38a and 38b assimilate back to form stable air atoms 38.

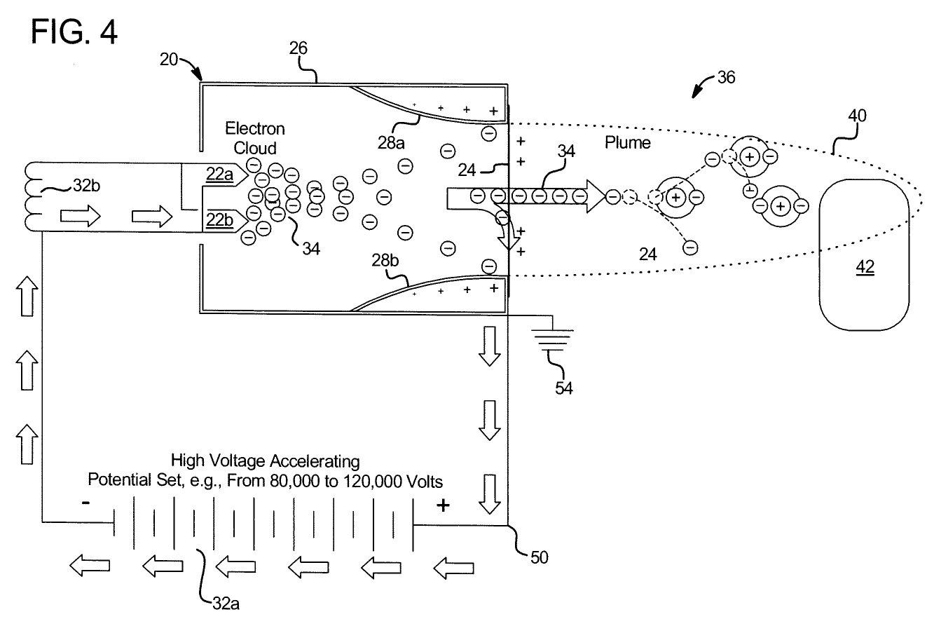

FIG. 4 illustrates that the collisions of the air receiving a direct electron strike frees other electrons, which perform secondary strikes, which in turn perform tertiary strikes, and so on. A plume 40 of gas in a very highly excited state (sometimes called a “plasma” because oxygen is not being consumed) appears as a nebulas and ultraviolet in color. Object or product 42 to be sterilized is conveyed within plume 40. The kinetic energy of the accelerated electrons within the plume 40 will, on contact with any material or object in the path of the plume, will displace electrons 34 in that object's atoms, dissipating some energy as work, some energy as heat, some energy as radiation in the visible ultra-violet frequencies, and also some energy in the x-ray frequencies.

Electron beam operation results in two hazardous bi-products, ozone and x-rays, which are contained within sterilization chamber 36 for human safety. The walls forming chamber 36 are made of stainless steel cladded-lead in one embodiment. A leaded glass window (not illustrated) can be placed in one of the walls to view plume 40. To actually determine that part 42 is properly sterilized and the corresponding radiation dosage, dosimetry film is used. A circular dot of the film, for example, can be punched out of the film. The dot of dosimetry film is affixed to a part 42 to be sterilized and passed through electron beam plume 40. Under exposure to plume 40, the color of the dosimetry dot changes from clear to pinkish-red. The density of the opaqueness of the color of the dot is measured on a photo-scanner and quantified against a varying opaqueness chart provided by the manufacturer of the film. The quantification matches the opaqueness to a specific irradiation dosage in units of kilo-gray for example. As discussed herein, the monitoring method of the present disclosure generates a signal during the sterilization of product 42. The signal level recorded for a product 42 having an exposed dosimetry dot that yields an adequate sterilization quantification (or perhaps a slightly lower level) is set as a threshold signal level that EOMS system 10 needs to maintain to ensure that proper sterilization is taking place.

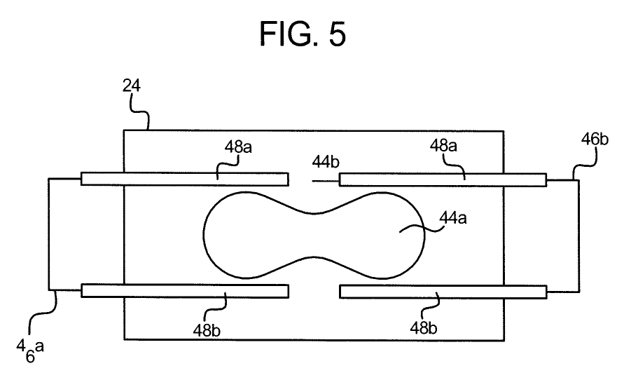

An experiment was performed to determine the profile shape or pattern of plume 40. Large sheets of dosimetry film were placed at different distances away from the electron beam window 24. As seen in FIG. 5, it was found that the pattern 44a appeared as a raccoon's eye pattern, which if superimposed onto window 24, would be located centrally within the ten inch wide window as seen in FIG. 5. Each “eye's” contribution comes from one of the two filament heaters 22a and 22b that boil off electrons 34 within generator 20. It was determined accordingly that each “eye” should be monitored independently. EOMS system 10 advantageously has the capability of sensing when either filament 22a or 22b malfunctions, such malfunctioning resulting in an insufficiently sterilized part of the product 42 conveyed through the system. System 10 can thereby reject the product 42 for re-sterilization at a different time or by a different generator 20 as opposed to being totally discarded as bad product when film dosimetry shows that the product (or product in a same batch as the product) has been sterilized improperly. The independent monitoring also solves the problem in which a fractured filament (22a or 22b) shorts against a functioning filament (the other of 22a and 22b) so as to mask the failure problem described above.

Electrons 34 shower object 42 similar to light from a flashlight hitting a wall. Central raccoon eye area 44a, in which many electrons strike, is bright and is referred to herein as the “umbra” of the electron output. Area 44b around umbra 44a is a fringe area of less intense striking, which is referred to herein as the “penumbra” of the electron output. In the illustrated embodiment, a pair of probes 46a and 46b is placed in the penumbra fringe 44b to sample the electrons, so that probes 46 (referring collectively to probes 46a and 46b) do not impact the primary sterilizing electrons 34 of umbra 44a. In the embodiment illustrated in FIG. 5, each probe 46a and 46b includes an upper branch wire 48a and a lower branch wire 48b, which are placed respectively in fringe penumbra 44b at the top and bottom of central umbra area 44a. A gap, e.g., one inch gap, is maintained between probe wire tips to minimize the cross-talk of signals picked-up between probes 46a and 46b of the left probe assembly with that of probes 46a and 46b of the right probe assembly. Each probe assembly monitors its own portion of the raccoon's eye part of the overall plume. The signals of branch wires 48a and 48b are summed as discussed in detail herein. The positioning of branch wires 48 (referring collectively to wires 48a and 48b) and probes 46 provides good coverage and sensing ability for the entire generator 20 without interrupting the main sterilizing area of plume 40. Wires 48 are installed inside an insulating support (discussed below), which holds branch wires 48 parallel to window 24. While horizontally disposed branch wires 48 are shown and preferred in one embodiment because they do not obstruct umbra 44a at all, it may be possible to provide vertically disposed branch wires 48, with the inner branch wires located in the narrowed, central part of umbra 44a. The probe wires are further alternatively a single “U” or “C” shaped wire that extends around each “eye” of the raccoon pattern.

Branch wires 48 collect fringe electrons 35 as those electrons fly by. Many metals oxidize rapidly in the presence of ozone, making such metals less conductive at there surfaces. Branches 48 are accordingly pure gold in one embodiment, which is a very good conductor and will not oxidize. It may be possible to use gold plated copper, however, it is expected that the copper will eventually leach to the surface of branches 48 and become coated cupric oxide, an insulator. Likewise, one preferred material is 24 karat gold, which is about 99.99% pure. 18 karat gold has about 25% copper, causing the above-mentioned leaching and insulating patina. The electrical resistivity of gold is 2.44×10⁻⁸ ohm-meter. In comparison, the electrical resistivity of copper is 1.72×10⁻⁸ ohm-meter. Both metals are excellent electrical conductors.

Gold branches 48 degrade minimally over conductive surface areas over time, so that they operate reliably without an appreciable inherent gradual drop in input signal. It is expected that the surfaces of gold branches 48 will erode 0.001 inch per year in the constant presence of ozone, which is acceptable. Gold branches 48 are chemically inert and do not bring or cause contamination when used in a medically sterile environment. Gold branches do not react with most chemicals and are insoluble in nitric acid. Gold branches 48 melt at 1948° F., which is also acceptable. A larger diameter branch wire, e.g., 12 AWG, affords a larger electron capture area and withstands erosion better.

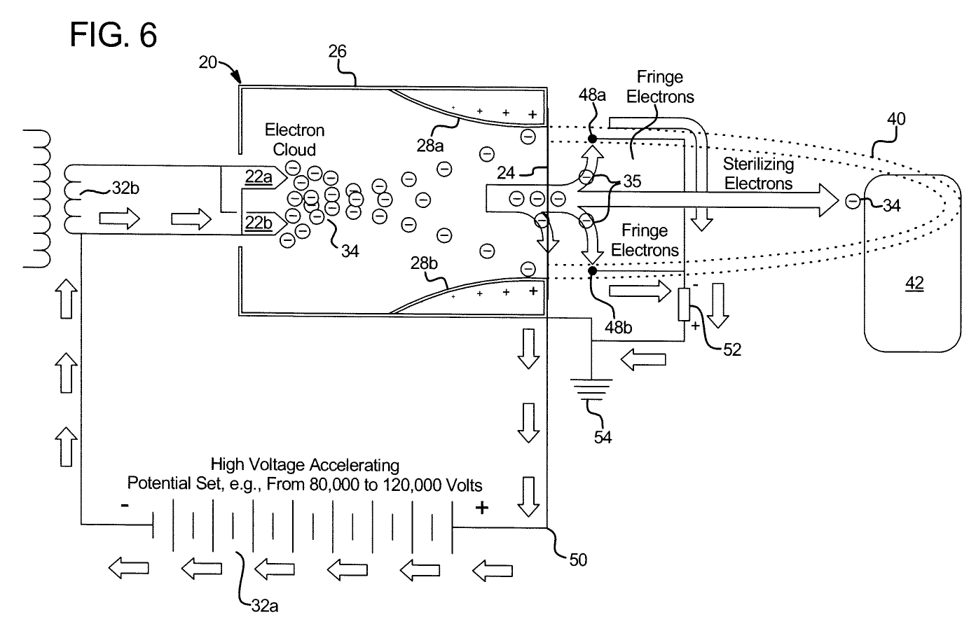

FIG. 6 illustrates the operation of probe 46 having branches 48 with electron generator 20. The electrons collected by branches 48 are referenced to ground 54 to make a meaningful measurement value. Any stray electrons not emitted from the electron beam tube 20 are returned via return loop 50 to electron the tube. The small pickup current 35 is converted into a voltage by passing the current through a high precision resistor 52 in a series connection on its way to ground. A precision resister is desirable, so that system 10 can provide an accurate and repeatable output when tested at the bench and then when installed at the medical sterilization application. A low ohmic value for the resistor minimizes extraneous noise pickup via e-field antenna pickup and m-field effects of magnetic induction into the input loop.

The voltage developed across the resistor is a common mode signal (referenced to ground) and is susceptible to outside noise. Any means of measuring this voltage with another, remote, ground connection may enact a ground loop problem. A difference between ground potentials would add an error voltage to the signal to be measured. Accordingly, EOMS system 10 attempts to provide signal amplifying and processing circuits that measure the differential voltage across resistor 52 without adding additional grounds. This results in two electrical conduits 56a and 56b running from generator 20 to the signal conditioning and comparing circuitry as seen in FIG. 2. System 10 also provides optical and capacitive coupling to the outside world and a power supply isolated by transformers, so that the electronics of system 10 float and are not tied to any other external electric circuit other than the two probe connections.

More specifically, fringe electrons 35 that branches 48 pick up are returned to the current loop 50 of generator 20. The current signal is converted into a voltage signal by placing a resistor 52 between branches 48 and ground 54. The resistance of resistor 52 is in one embodiment relatively low so as not to be susceptible to extraneous noise pickup, tolerance changes or the internal generation of thermal noise due to changes in temperature. In one implementation, resistor 52 is an ultra-precision resistor of ten Ohms, which is sufficiently low in value to almost represent a short circuit, quenching the small collected signal very little. The low value of resistor 52 provides a sufficiently small load such that little noise is coupled inductively to resistor 52. To minimize resistance variance, ultra-precision resistor has a tolerance of 0.01 percent in one implementation.

The voltage signal is a small direct current (“DC”) component, negative in polarity, with respect to ground 54. Tube 20 and resistor 52 tied to earth ground 54 introduce common-mode noise voltages to the small DC signal. The DC voltage signal is accordingly buried in a relatively very large white noise alternating current (“AC”) signal produced by the surrounding gas plasma of plume 40. A switching power supply is not used because it would introduce unwanted ripple noise. The signal is isolated electrically from the outside world. Signal conditioning and comparing circuitry 30 can be battery operated to provide such isolation. In one preferred embodiment, circuitry 30 includes a transformer isolated, linear DC power supply.

As seen in FIG. 2, coaxial cables 56a and 56b carry the signal through lowpass filters 58a and 58b, respectively, to amplifier circuitry. The outer braided jackets of coaxial cables 56a and 56b provide a first line of defense against outside noise. Additionally, lowpass filters 58 (referring collectively to filters 58a and 58b) attenuate AC frequency components above a certain frequency, e.g., sixty hertz.

Circuitry 30 includes a first amplifier 60, which can be an instrumentation amplifier that has been carefully balanced to amplify the voltage signal. Amplifier 60 employs active signal guarding apparatus 62. Guarding apparatus 62 sees a noise component common to the differential signals of cables 58a and 58b and sends signals back to the shield of each shielded cable 56a and 56b, one hundred degrees out of phase with the incoming noise to provide active noise cancellation, which is yet another layer of filtration of the signal. To this end, coaxial cables 56a and 56b are kept equal in length and are tied together, so that any noise pickup is induced in both cables 56 (referring collectively to cables 58a and 58b), at the same time and with the same amplitude.

The desired DC signal is a differential voltage applied to the input of amplifier 60, which alone is amplified (AC frequencies filtered out). Instrumentation amplifier 60 in one implementation multiplies the DC signal by a gain of 500 to 1000 times. It is desirable that the overall gain adjustment achieve a typical voltage range used in the industrial community, such as zero to five VDC. To this end, a post gain amplifier 64 is added in series with instrumentation amplifier 60. Post gain amplifier 64 adds additional low pass filtering via the integration of the differential signal components along cables 56 to a single signal. It was anticipated that the plasma driven signal might bobble appreciably. It has been found, however, that the resulting amplified DC signal is very stable even for different voltage threshold setpoints. Amplifiers 60 and 64 also reverse the polarity from a negative going input to a positive going output by reversing the input feed connections. In one embodiment, each amplifier 60 and 64 is mounted in its own aluminum enclosure to protect against adverse extraneous noise. The enclosures are contained in another, grounded enclosure.

Circuitry 30 includes power supply circuitry 70 configured to supply voltages that do not electrically “tug” at the amplifier circuitry 60, 62 and 64 and change the positive going output artificially. Circuitry 70 includes an electromagnetic interference/radio frequency interference (“EMI/RFI”) filter 66 that blocks extraneous noise riding on the 120 VAC line voltage, to which powers dual ±12 VDC power supply 68. The plus 12 VDC and minus 12 VDC portions of power supply 68 are independent of each other and may not be matched very well. Accordingly, the output of 12 VDC linear power supply 68 is sent to a dual ±6 VDC tracking power supply 72. Here, if the +6 VDC portion of power supply 68 varies, the −6 VDC potion of supply 68 varies within millivolts of the +6 VDC portion. The virtual ground between ±6 VDC power supply 72 remains very close to zero volts regardless of temperature variations or line voltage variations. System 10 accordingly achieves circuit balance through component value matching and power supply voltage matching to cancel extraneous noise, which prevents the output signal from being manipulated artificially by power voltages. Power supply circuitry 70 is accordingly buffered against any line voltage changes that occur in the plant environment.

The outputted zero to five VDC signal is in one embodiment applied to three different stages. The first stage is a threshold detector stage, which compares the incoming signal level with a manually settable DC threshold voltage. If the signal maintains a level above this threshold (the electron beam output is sufficient to perform sterilization), EOMS system 10 indicates so. If the signal falls below the threshold value, the system alarms. An auxiliary part of the detector stage sends (or removes) a digital signal to (from) a remote PLC to tell the controller that a malfunction has occurred. The PLC measures the duration of this low level alarm and takes appropriate corrective action. A second bargraph display stage includes a multi-segment vertical bargraph display that indicates the relative level of the zero to five VDC signal during operation. A third stage is an isolated analog buffer stage, which includes a capacitively isolated input and output section. The replicated output is used to drive an external paper chart recorder for the historical recording of the electron beam current levels. The outputted chart is forwarded, e.g., daily, to the plant documentation center for archival. It should be appreciated that each electron generator 20 of system 10 is recorded on multi-penned recorder.

Specifically, EOMS system 10 monitors the output of electron beam generator 20 and alarms if the output falls below a set threshold. The threshold as discussed is an empirically determined threshold, which indicates that the total energy of plume 40 is sufficient to sterilize product 42 properly, e.g., provides enough output to achieve a sufficient amount of kilo-gray dosage to the product. If not, system 10 outputs immediately to the operator so that no product is lost. To this end, signal conditioning and comparing circuitry 30 includes a voltage comparator 74 that compares the positive going signal outputted from amplifier 64 to a reference voltage corresponding to the above threshold, which is supplied by precision voltage reference apparatus 76. Apparatus 76 in one embodiment is a precision voltage reference integrated circuit chip, which has a voltage stability of 100 parts per million per year. Apparatus 76, which is manually settable, supplies a precise voltage and is accurate and stable over a large temperature range.

FIGS. 1 and 2 show that voltage comparator 74 outputs to a plurality of entities including threshold and alarm circuitry 80, a bargraph display 110 and analog outputs 120. The output state change of voltage comparator 74 is used to trigger alarm circuitry 80. If the electron output is above the reference threshold from precision reference 76, alarm circuitry 80 indicates this by lighting a bi-color light emitting diode (“LED”) 90 a steady green in one implementation. However, if the electron output drops below the reference threshold from precision reference 76, LED 90 changes to a flashing red indication in one implementation.

FIGS. 1 an 2 further show that the output state change of voltage comparator 74 also switches on an optically coupled LED 100, which in turn causes an input to be made to an optical link of a programmable logic controller (“PLC”) 140. This optical link further serves to isolate the circuitry of system 10 from the outside world. The output of optical coupler 100 is powered via the power supply of PLC 140 in one embodiment.

Under normal operation, the input to PLC 140 is held on or sourced. The failure of electron beam generator 20 cause this signal to turn off, which in turn is treated by the overlying sterilization machine as an emergency stop, and which cuts power to select devices, such as the conveyor moving product 42 and first and second generators 20.

System 10 also provides a visual indication to the operator of the real time operation of generator 20. FIG. 2 shows that amplifier 64 also outputs the analog, e.g., zero to five VDC, amplified signal to a readout 110, such as a twenty or eighty-segment LED bargraph display. Display 110 has two modes in one embodiment, bar and dot. In bar operation, all LED's of display 110 are non-illuminated when the voltage is zero. More and more LED's of display 110 are illuminated as the voltage increases. All LED's are illuminated when five VDC volts is reached. In the dot operation of display 110, only one LED is lit at a time as the voltage increases. Here, the LED's gradually pass their brightness from one to another, so that the LED's never all appear off unless the input voltage is zero. Display 110 includes a switch 112 that allows an operator to switch display 110 from the bar mode of operation indicating signal level to the dot mode of operation to indicate the point at which the threshold is set. That is, in one embodiment the bar mode is an online or operational mode that shows the signal level varying as a vertical bar that rises and falls. The operator switches to an offline dot mode to view and set the threshold or trip point, which is not seen when the mode is switched back to the operational mode.

FIGS. 1 and 2 further show that amplifier 64 also outputs the analog, e.g., zero to five VDC, amplified signal to a capacitively coupled linear isolation amplifier 120. Here, an exact duplicate of the zero to five volt input signal applied at the input of amplifier 120 is created at its output. Both sections are separated by a, e.g., one picofarad, capacitor that isolates input from output with a high breakdown barrier voltage, which minimizes ingress of noise signals bi-directionally. Capacitively coupled amplifier 120 breaks any galvanic connection between input and output commons and in one embodiment provides a minimum of 750 volts breakdown between the input and the output of the amplifier. The amplifier output stage dual voltage is supplied from an independent power supply, e.g., one fed via the cabinet of PLC 140. In the illustrated embodiment, amplifier 120 drives a multi-channel chart recorder 130, which records historical data for both electron generators 20 of the sterilization system. If either filament 22a or 22b of either generator 20 fails, recorder 30 tells the operator which generator 20 has failed.

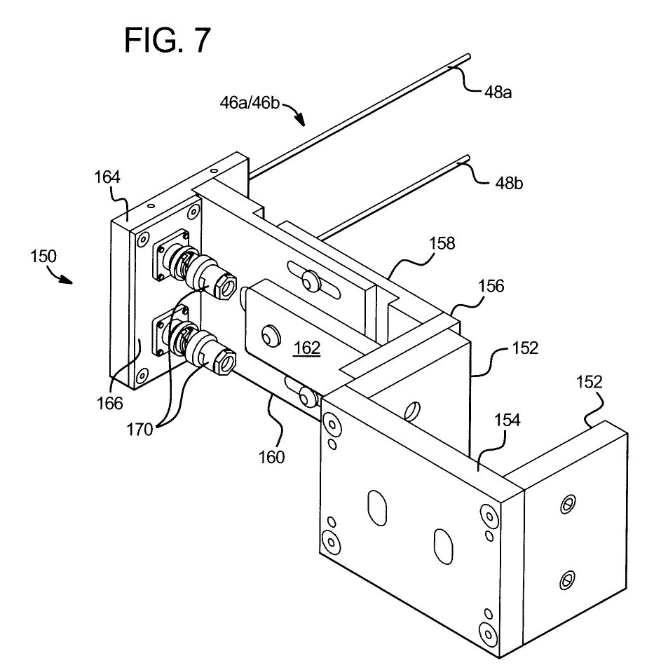

Referring now to FIG. 7, assembly 150 illustrates one possible mounting configuration for the mounting of probes 46a and 46b, each having first and second probe branches or wires 48a and 48b. Assembly 150 mounts one of the probes 46a or 46b. The other of the probes is mounted via a separate assembly 150. The two assemblies 150 are mounted to the left and right sides of one electron generator 20, which sterilizes a front side of product 42. A second pair of assemblies 150, left and right, can then be mounted to or are otherwise be dedicated to a second electron generator 20, which sterilizes a back side of product 42, such that the entire product 42 is sterilized and monitored.

Assembly 150 includes first and second clamp ends 152 bolted to a clamp spacer 154, each of which can be stainless steel. Clamp ends 152 and clamp spacer 154 bolt assembly 150 to electron generator 20 or other nearby apparatus. Mount base 156 bolts adjustably to one of the clamp ends 152 and allows for adjustment of branches 48a and 48b towards and away from the opposing set of branches 48a and 48b to set a desired gap, e.g., one inch, between the two sets of probe branches 48. A mount slide 158 is bolted to mount base 156. Mount slide 158 and mount base 156 are also made of stainless steel in one embodiment.

A holder slide 160 bolts adjustably to mount slide 158 and allows for adjustment of branches 48a and 48b towards and away from electron generator 20 and window 24. It is desirable in one aspect to move probe branches 48a and 48b further away from window 24 and closer to product 42 to sense closer to the product. Electron plume 40 weakens however as probe branches 48 are moved away from window 24, making placement closer to window 24 desirable for that reason.

It is also desirable to place probe branches 48 in front of a shutter (not illustrated) that is placed between the electron beam generator 20 and products 42 (one on each side of products 42 for each generator 20). The shutters remain closed until one or more product 42 is conveyed into sterilization zone 36. The shutters then open for a specified period of time to allow for a proper amount of electron beam bombardment. The shutters then close prior to the sterilized product being conveyed away from electron beam generators 20. It is recommended by electron beam manufacturers to operate generator 20 continuously at a specific voltage and current to achieve adequate sterilization of the object placed at a certain distance. The primary reason for running generator 20 continuously is to prevent duty cycling the generator on and off, which helps to prevent (i) premature filament failure, (ii) changing filament output, and (iii) power supply regulator fluctuations. The electron beam shutter allows electron beam generator 20 to be powered constantly and in a steady state, opening only when the product is stationary and in view. This prevents pre-sterilization of product 42 as is comes into the beam, which would make quantifying a specific sterilization time more difficult. The product conveyor doors are opened only when the shutters are down, so that radiation escaping the sterilization chamber 36 via the doors is minimized. The shutters also prevent overexposed sterilization due to a conveyor line stoppage.

Placing probe branches 48 in front of the shutter is simpler mechanically and allows the resulting small zero to five VDC signal to be constant rather than switched on and off via a shutter. Probe branches 48 monitor the electron beam output continuously. The electron output may rise during the shutter down position, due to the backscatter off of the shutter surface. This may increase the input current to a slightly higher value above the minimum criterion for proper output. Even if so, system 10 is configured to alarm when the electron output drops below the safe threshold value to ensure proper sterilization.

Even if probe wires 48 are placed closer to window 24, an empirically determined signal corresponding to a tested and verified dose of electron beam energy can be determined and set as a setpoint. It is important however that assembly 150 hold the probe branches 48 thereafter at the same set distance from window 24. If holder slide 160 is adjusted for whatever reason, EOMS system 10 needs to be recalibrated. A retainer 162 is provided accordingly to help hold holder slide 160 in the set position. Holder slide 160 and retainer 162 are also made of stainless steel in one embodiment.

In an alternative embodiment, the probe assembly resides between the shutter and the part, so that the shutter commutates the received signal. Here, the logic of PLC 140 is programmed to acknowledge the rising and lowering shutter position states and to not alarm when the shutter is down.

A probe holder 164 is bolted to holder slide 160. An associated probe cap 166 is bolted to probe holder 164. As discussed herein, the electron beam sterilization process produces secondary effects: heat, radiation and ozone. Rapidly accelerating electrons of the beam strike an object and release energy in the form of heat and radiation (x-rays). As the electrons sear their way through the air to the part, they subtract from or add to electrons in the atoms in the air molecules producing O₃. Probe holder 164 and cap 166 accordingly not only need to be electrically insulating and capable of holding conductive probe wires 48a and 48b, the holder and cap also have to be chemically and mechanically stable in the presence of heat, x-rays, and ozone.

Probe holder 164 and cap 166 are accordingly machineable ceramic in one preferred embodiment. Machineable ceramic can be tooled, withstand extreme heat, does not molecularly scission or become brittle in the presence of x-rays, and is impervious to ozone exposure. Teflon is good for O₃ but is susceptible to x-rays. Urethane or Polyurethane with greater than 75 durometer is rigid enough to support the probes and is excellent for ozone and x-rays but may discolor and deform under thermal stress from the electron beam plume 40.

Placement of the probes 46 as discussed is made to collect as much of the peripheral electron output from plume 40 without sacrificing the main sterilization intent. In the illustrated embodiment, probe branches 48 are placed via holder 164 horizontally across, above and below plume 40. Assembly 150 also allows probe branches 48 to be centered about the horizontal centerline of the electron beam window 24 in one embodiment (see FIG. 5). In one embodiment, two gold probe wires 48a and 48b extend approximately five inches into the window area, horizontally from the side of the window.

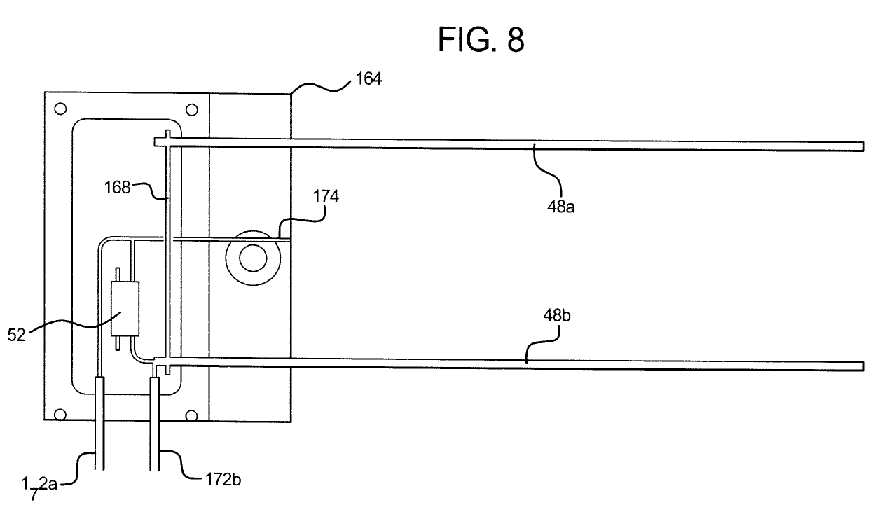

As seen in FIG. 8, the signals from branches 48a and 48b are summed by tying them electrically together with a bridging wire 168 located inside probe holder 164 to form a U-shaped conductor. Electrical connectors 170 (FIG. 7) coupled to probe cap 166 connect to the same-length coaxial cables 56a and 56b discussed above, which carry the differential signal lines 172a and 172b (FIG. 8) to signal conditioning and comparing circuitry 30. A ground wire 174 exits the probe holder body and connects to the nearest, earth grounded connection of the electron beam tube. In one preferred embodiment, ground wire 174 is connected directly to the e-beam tube housing face, with minimal metal-to-metal panel surface interfacing.

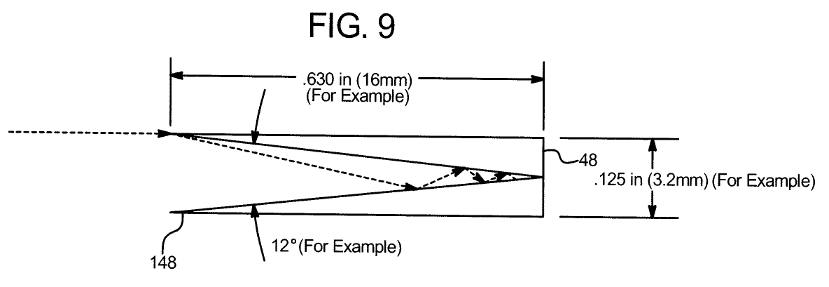

Referring now to FIG. 9, one cross-sectional configuration for probe wires 48 is illustrated. Probe wires 48 can be circular in cross-section, triangular in cross-section, square in cross-section, rectangular in cross-section, solid, hollow, or meshed. FIG. 9 shows another alternative cross-section in which probe wire 48 includes a chiseled edge 148 pointed towards window 24 when the probe wire is mounted, which captures electrons via an anecoic tunnel capture. Sample dimensions are shown in FIG. 9, however chiseled wire 48 can depart from the dimensions shown. Chiseled wire 48 can be extruded or formed by splicing two separate triangular halves. A similar and potentially more readily available extruded cross-sectional shape is a half-moon shape, which is also contemplated.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

The invention is claimed as follows:

1. A medical container sterilization apparatus comprising:
an electron beam generator;
a probe placed in proximity to an electron plume projected from the generator; and
electronics configured to accept a signal carried by the probe, the signal indicative of a sterilization level of the electron plume, the electronics further configured to indicate if the sterilization level is not sufficient.

2. The medical container sterilization system of claim 1, the electronics configured to indicate if the sterilization level is not sufficient based on an experientially determined sufficient level.

3. The medical container sterilization system of claim 1, the probe a first probe, and which includes a second probe placed adjacent to the plume.

4. The medical container sterilization system of claim 3, wherein at least one of: (i) each probe includes first and second wires placed above and below the plume and (ii) each probe is dedicated to a separate heater filament's portion of the electron plume.

5. The medical container sterilization system of claim 1, wherein the probe is at least one of: (i) gold; (ii) circular in cross-section; (ii) triangular in cross-section; (iii) square in cross-section; (iv) rectangular in cross-section; (v) chiseled on an edge, (vi) solid; (vii) hollow; (viii) meshed; and (ix) connected electrically to earth ground.

6. The medical container sterilization system of claim 1, the electronics including filtering to remove an alternating current component of the signal.

7. The medical container sterilization system of claim 1, the electronics including at least one amplifier configured to amplify the signal.

8. The medical container sterilization system of claim 1, wherein the electronics are isolated from all outside electronics.

9. The medical container sterilization system of claim 1, wherein the electron plume imparts a current onto the probe, the electronics including a resister positioned to convert the current into a voltage signal, the voltage signal indicative of the sterilization level of the electronic plume.

10. The medical container sterilization system of claim 9, the electronics configured to send the voltage signal to at least one of: (i) a voltage comparator; (ii) a readout display; and (iii) an output recorder.

11. The medical container sterilization system of claim 1, the electronics including alarm circuitry configured to provide normal operation and system failure indication.

12. The medical container sterilization system of claim 1, the electronics coupled to a controller programmed to operate at least one of the electron beam generator and a conveying apparatus for conveying the medical container.

13. The medical container sterilization system of claim 1, which includes a plurality of electron beam generators and a probe positioned adjacent to the electron plume of each generator.

14. The medical container sterilization system of claim 13, at least some of the electronics repeated for each generator.

15. The medical container sterilization system of claim 1, wherein the probe is mounted to a housing at least partially exposed to the electron plume, the housing made of ceramic.

16. The medical container sterilization system of claim 1, which is configured such that the electrons collected by the probe and forming the signal indicative of the sterilization level are fed through a return loop to the electron beam generator.

17. The medical container sterilization system of claim 1, which includes first and second probes connected to the electron beam generator by first and second conductors, respectively, the first and second conductors having at least substantially a same length.

18. A medical container sterilization method comprising:
collecting electrons from a sterilizing electron plume;
generating a signal from the collected electrons; and
determining from the signal whether the electron plume is sufficient to properly sterilize the medical container.

19. The medical container sterilization method of claim 18, wherein determining from the signal whether the electron plume is sufficient to sterilize the medical container includes comparing the signal to a reference signal.

20. The medical container sterilization method of claim 18, wherein determining from the signal whether the electron plume is sufficient to sterilize the medical container includes experimentally determining a sufficient level for the signal and determining if the signal meets the sufficient level.

21. The medical container sterilization method of claim 18, wherein collecting electrons includes placing a probe adjacent to the electron plume.

22. The medical container sterilization method of claim 18, wherein generating the signal includes forcing the electrons through a resistor and measuring a voltage across the resistor.

23. The medical container sterilization method of claim 18, which includes at least one additional step selected from the group consist of: (i) filtering the signal and (ii) amplifying the signal.

24. A medical container sterilization method comprising:
collecting electrons emitted from an electron beam generator;
returning the electrons along a loop to the generator;
measuring from the loop a signal indicative of an amount of electrons collected; and
determining from the signal whether the amount of electrons collected represents a sufficient level of sterilization of the medical container.

25. The medical container sterilization method of claim 24, wherein collecting electrons includes collecting electrons within an electron plume penumbra.
